(19) United States
(12) Patent Application Publication
(10) Pub. No.: US 2015/0301748 A1
(43) Pub. Date: Oct. 22, 2015

(54) STORAGE OPERATING SYSTEM

(71) Applicant: SAMSUNG ELECTRONICS CO., LTD., SUWON-SI (KR)

(72) Inventor: HYUN-SEOB LEE, ANSAN-SI (KR)

(21) Appl. No.: 14/682,223

(22) Filed: Apr. 9, 2015

(30) Foreign Application Priority Data
Apr. 21, 2014 (KR) 10-2014-0047599

(51) Int. Cl. G06F 3/06

(52) U.S. Cl. CPC G06F 3/0611; G06F 3/0688; G06F 3/0655; G06F 3/0653

(57) ABSTRACT

A storage system includes a plurality of unit storages each including at least one flash memory chip. Performance of at least a first storage of the unit storages is monitored. A first type of request for the first storage is processed using a second storage of the unit storages, instead of using the first storage, if the performance monitoring indicates that the first unit storage has reached an end-of-life state.

### CROSS-REFERENCE TO RELATED APPLICATION

This application claims the benefit of Korean Patent Application No. 10-2014-0047599, filed on Apr. 21, 2014, in the Korean Intellectual Property Office, the disclosure of which is incorporated herein in its entirety by reference.

### BACKGROUND

The inventive concept relates to a storage device, a storage system, and a method of operating the storage system, and more particularly, to a storage device and storage system capable of efficiently maintaining performance thereof, and a method of operating the storage system.

A storage device or having high performance and/or capacity, and reliability of data stored in the storage device or system are desired. For example, it would be desirable to have a reliable scheme for replacing a failed part when part of the storage device or system fails.

### SUMMARY

In one aspect of the inventive concept, a method of operating a storage system including a plurality of unit storages each including at least one flash memory chip comprises monitoring performance a first unit storage among the plurality of unit storages; determining that the first unit storage is in a first state when a monitored performance value of the first unit storage exceeds a reference value; and if a first type of request for the first unit storage is received subsequent to a determination that the first unit storage is in the first state, then using a second unit storage to process the first type of request.

In another aspect of the inventive concept, a method of operating an SSD comprises monitoring performance of each of a plurality of flash memory chips of the SSD including at least first and second flash memory chips; determining, based on the monitoring, that a first flash memory chip among the plurality of flash memory chips is in an end-of-life state, and subsequently receiving a request for the first flash memory chip. If the request is a write request, the second flash memory chip is used to process the write request, but if the request is a read request, then the first flash memory chip is used to process the write request.

In yet another aspect of the inventive concept, a storage system comprises a controller and a plurality of flash memory chips including at least first and second flash memory chips. The controller is configured to monitor performance of and control the flash memory chips; to determine, based on the monitoring, whether the first flash memory chip is in an end-of-life state; to receive a write request for the first unit storage; to use the first flash memory chip to process the write request if the first flash memory chip has not been determined to be in the end-of-life state; and to use the second flash memory chip to process the write request if the first flash memory chip has been determined to be in the end-of-life state.

### BRIEF DESCRIPTION OF THE DRAWINGS

Exemplary embodiments of the inventive concept will be more clearly understood from the following detailed description taken in conjunction with the accompanying drawings in which:

FIG. 1 is a flowchart illustrating a method of operating a storage system according to an embodiment of the inventive concept;

FIG. 2 is a block diagram of a storage system according to an exemplary embodiment of the inventive concept;

FIG. 3 is a view illustrating an example of a solid state drive (SSD) included in the storage system of FIG. 2;

FIG. 4 is a view for describing operation of the SSD of FIG. 3 in more detail;

FIG. 5 is a view of a mobile device according to an exemplary embodiment of the inventive concept;

FIG. 6 is a graph illustrating change with time in the performance of an SSD or a flash memory chip in accordance with an exemplary embodiment of the inventive concept;

FIG. 7 is a view illustrating an exemplary embodiment of memory blocks included in a flash memory chip according to an embodiment of the inventive concept;

FIGS. 8A and 8B are views illustrating exemplary embodiments of a method of physically replacing the first unit storage of FIG. 1 with a second unit storage;

FIGS. 9 to 12 are views illustrating exemplary embodiments of the storage system of FIG. 2;

FIGS. 13 and 14 are flowcharts illustrating an example of operation of a second unit storage processing a first request for the first unit storage of FIG. 1;

FIG. 15 is a view illustrating an example of a cell array of a flash memory chip according to an exemplary embodiment of the inventive concept; and

FIG. 16 is a view of a server system and a network system including the SSD of FIG. 3.

### DETAILED DESCRIPTION OF EMBODIMENTS

The inventive concept will now be described more fully with reference to the accompanying drawings, in which exemplary embodiments of the inventive concept are shown. The same elements in the drawings are denoted by the same reference numerals and a repeated explanation thereof will not be given. The inventive concept may, however, be embodied in many different forms and should not be construed as limited to the exemplary embodiments set forth herein. Rather, these embodiments are provided so that this disclosure will be thorough and complete, and will fully convey the scope of the inventive concept to one of ordinary skill in the art. In the drawings, the thicknesses of layers and regions are exaggerated for clarity.

Unless otherwise defined, terms such as “include” and “have” are for representing that characteristics, numbers, steps, operations, elements, and parts described in the specification or a combination of the above exist. It may be interpreted that one or more other characteristics, numbers, steps, operations, elements, and parts or a combination of the above may be added. Unless otherwise defined, all terms (including technical and scientific terms) used herein have the same meaning as commonly understood by one of ordinary skill in the art to which this inventive concept belongs.

In an embodiment of the present inventive concept, a three dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In an embodiment of the present inventive concept, the 3D memory array includes vertical NAND strings that are vertically oriented such that at least one memory cell is located over another memory cell. The at least one memory cell may comprise a charge trap layer.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

In a solid-state flash memory cell, data can be written onto the medium of the memory cell, this data can be erased from the medium, and new data can be written onto the same medium. The sequence of erasing data that has been written to a solid-state flash memory cell and then writing over it again is called a solid-state-storage program-erase (P/E) cycle. Each such cycle causes a small amount of physical damage to the medium of the flash memory cell. Over time this damage accumulates, so that there is a limit to the number of P/E cycles that can be performed before the accumulated damage renders the cell unusable. Accordingly, counting the number of P/E cycles that have been performed can indicate how close the cell is to failure, and/or when the cell can no longer be relied on.

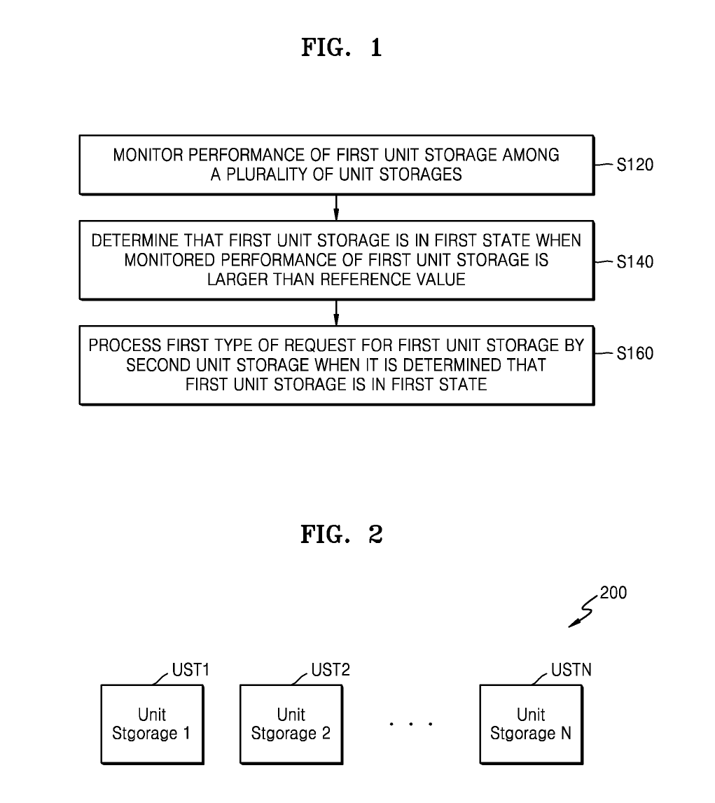

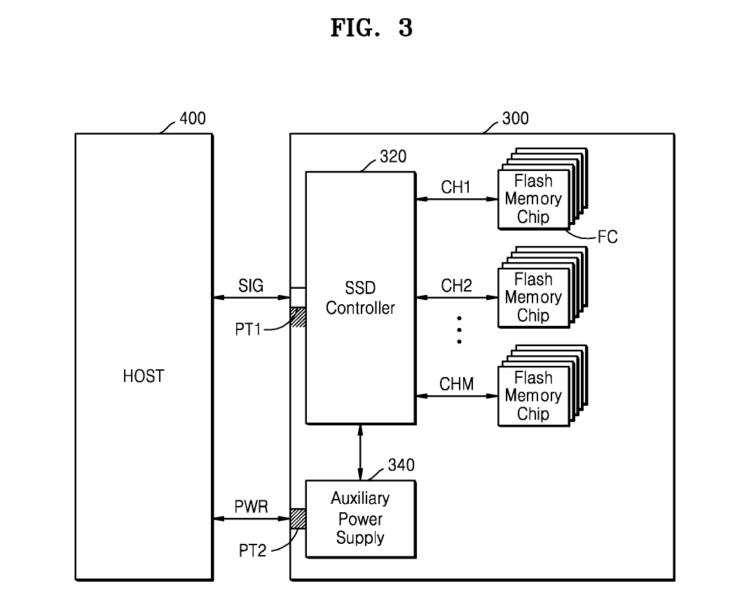

Referring to FIGS. 1 and 2, operating the storage system 200 may include monitoring (S120) performance of a first unit storage among a plurality of unit storages UST1, UST2, . . . , USTN. For example, in exemplary embodiments a performance value of the first unit storage (e.g., the number of P/E cycles that have been performed) may be monitored. The first unit storage is determined (S140) to be in a first state (e.g., a state of imminent failure, or an “end-of-life” state) when the monitored performance value of the first unit storage during operation becomes larger than a reference value, for example when the number of P/E cycles that have been performed exceeds a predefined limit.

Different types of requests for the first unit storage may be received. For example, read requests or write requests may be received. In exemplary embodiments, when the first unit storage is determined to be in the first state and a first type of request for the first unit storage is received, for example a write request, instead of using the first unit storage for processing the request, a second unit storage may be used to process (S160) the first type of request.

Accordingly, in exemplary embodiments once the number of P/E cycles performed on the first unit storage exceeds the predefined value, the first unit storage is determined to be in a failure or end-of-life (EOL) state and a subsequent write request for the first unit storage will be performed using a second unit storage instead.

In exemplary embodiments, the storage system 200 includes the plurality of unit storages UST1, UST2, . . . , USTN and each of the unit storages UST1, UST2, . . . , USTN includes at least one flash memory chip. FIG. 2 illustrates an example in which the storage system 200 includes the N unit storages UST1, UST2, . . . , USTN. In operating the storage system 200, the unit storages UST1, UST2, . . . , USTN may be understood as units for controlling failed operation. The unit storages UST1, UST2, . . . , USTN may be of various types. More detailed examples of the unit storages UST1, UST2, . . . , USTN will be described later. The flash memory chips included in the respective unit storages UST1, UST2, . . . , USTN may be NAND flash memories for example.

When the state of one of the unit storages UST1, UST2, . . . , USTN is such that the reliability of one of the unit storages is uncertain, that can be considered a failure state. For example, in accordance with the above explanation, when the number of program/erase (P/E) cycles of a flash memory chip included in the unit storage 1 (UST1) reaches a predefined threshold value, the unit storage 1 (UST1) may be considered and processed as a failure.

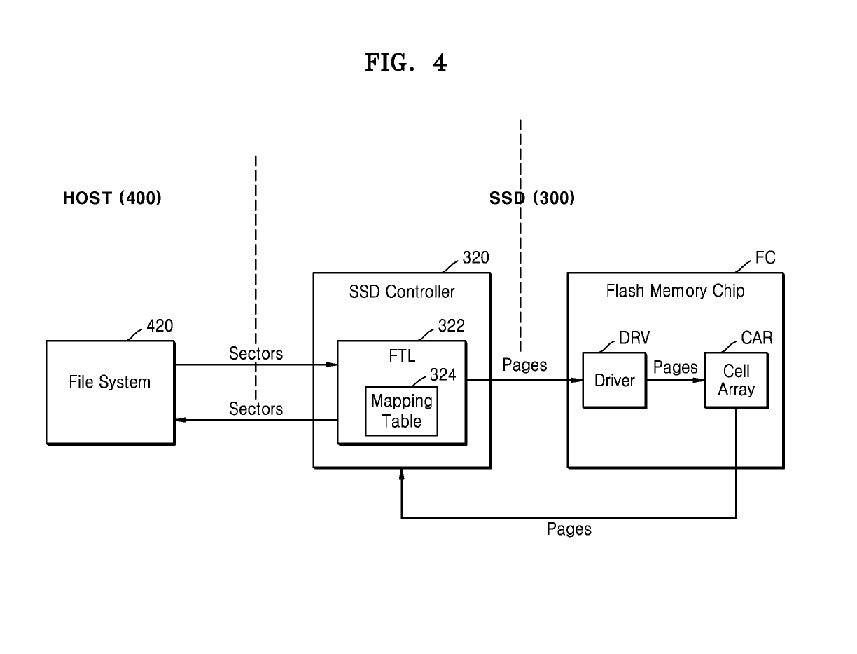

Referring to FIG. 3, a solid state drive (SSD) 300 included in the storage system 200 of FIG. 2 may include an SSD controller 320 and at least one flash memory chip FC. The SSD controller 320 may control the flash memory chips FC in response to a signal SIG received from a host 400 through a first port PT1. The SSD controller 320 may be connected to the flash memory chips FC through a plurality of channels (CH1 through CHM). Various aspects of the performance of the flash memory chips FC may be evaluated and measured. For example, performance of a flash memory chip FC may be evaluated by counting the number of uses, or P/E cycles, as explained above. In other possible embodiments one or more different characteristics of the flash memory chip FC relating to reliability may be monitored and quantified, and used in place of really counting the number of P/E cycles. For example, the number of bad blocks within a flash memory chip may be used as an indication of imminent failure, as explained below.

The SSD 300 may further include an auxiliary power supply 340 to receive power PWR from the host 400 through a second port PT2. The inventive concept is not limited thereto and the SSD 300 may receive power from external apparatus other than the host 400. The SSD 300 may output a signal (SIG) that results from processing a request of the host 400 through the first port PT1.

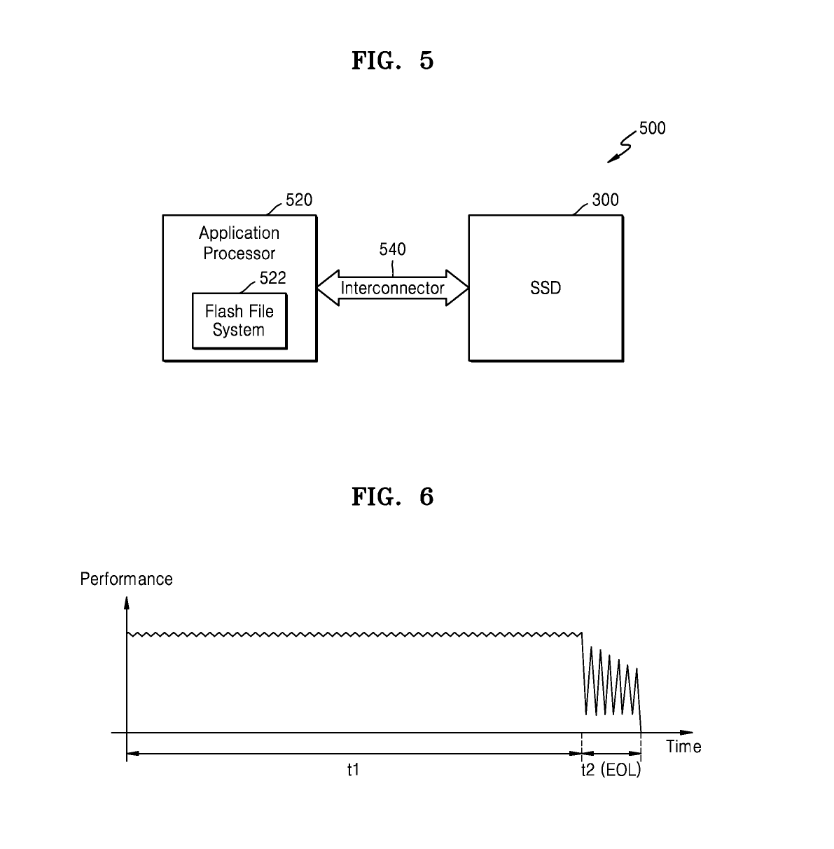

Referring to FIG. 4, a file system 420 of the host 400 performs a request for the SSD 300 in units of sectors. A flash translation layer (FTL) 322 that may be included in the SSD controller 320 of the SSD 300 may convert a logical address in units of sectors, corresponding to the request of the host 400, into a physical address in units of pages. The FTL 322 may convert the logical address into the physical address with reference to a mapping table 324. The FTL 322 may be loaded to a random access memory (RAM) (not shown) of the SSD controller 320. A driver DRV of a flash memory chip FC receives the physical address in units of pages, which is converted by the SSD controller 320, to physically approach a cell array CAR. A result of the cell array CAR performing a request may be provided to the host 400 in units of pages.

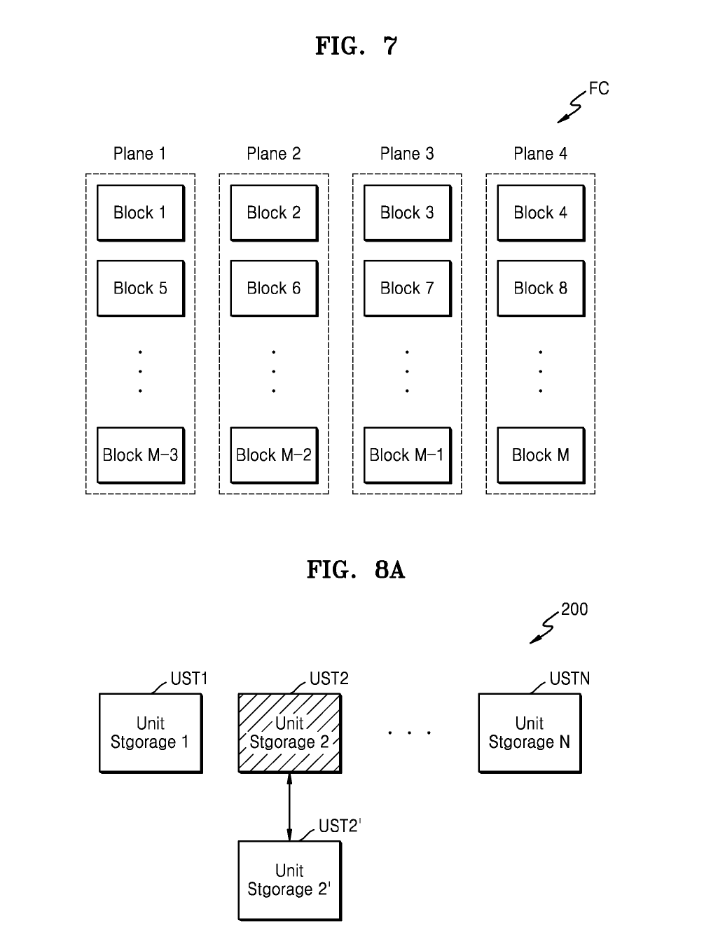

Referring to FIG. 5, the mobile device 500 may include an application processor 520 and an SSD 300 that communicates with the application processor 520 via an interconnector 540. The application processor 520 and the SSD 300 may correspond to the host 400 and the SSD 300 respectively, of FIG. 4. In addition, a flash file system 522 included in the application processor 520 of FIG. 5 may perform the same function as that of the file system 420 of FIG. 4. The flash file system 522 may support a log structure based file system function based on a characteristic, in which a flash memory may not be in-place updated, in order to improve stability and performance while performing as a common file system.

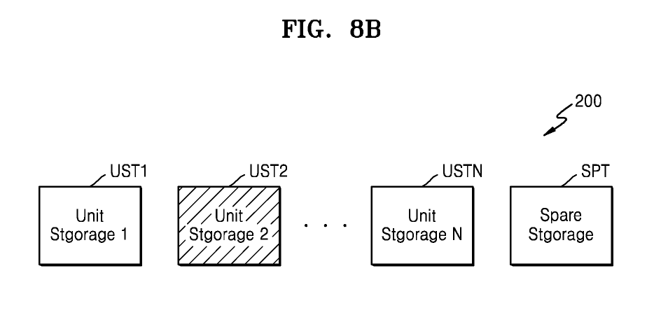

Referring to FIGS. 3 and 6, the SSD 300 or the flash memory chip FC operates with substantially uniform performance during time period t1. As the number of P/E cycles increases, the data-retaining ability of the flash memory chip may deteriorate. The SSD controller 320 performs wear-leveling in order to prevent P/E of a specific flash memory chip FC from being intensively generated, so that the performance of the flash memory chip FC may be maintained during the period t1. However, when period t1 ends and period t2 starts, the performance of the flash memory chip FC rapidly deteriorates once the number of P/E cycles of the flash memory chip FC reaches a reference (threshold) value. The state in period t2, in which the performance of the flash memory chip FC rapidly deteriorates, may be referred to as an end-of-life (EOL) state, also referred to herein as a “first state”. The storage system 200 may perform operations without deterioration before a particular unit storage (e.g., the first unit storage) is in the EOL state, as described in more detail below.

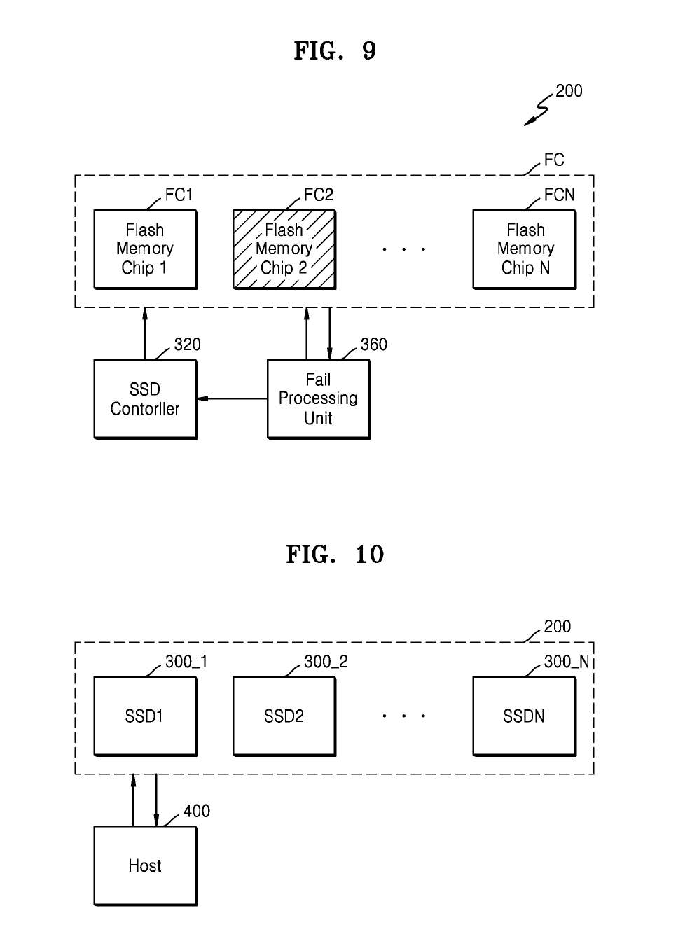

With reference to FIG. 7, the flash memory chip FC may include the plurality of memory blocks discussed above. Operations may be simultaneously performed on respective planes by using partial memory blocks as one plane. The flash memory chip FC may be implemented by one plane. When an arbitrary memory block among the plurality of memory blocks of the flash memory chip FC fails, the memory block is processed as a bad block and is replaced (or remapped) with one of reserved blocks and a request regarding the memory block is processed by the remapped reserved block. The number of reserved blocks may vary in accordance with the degree of a required performance of the flash memory chip FC. When the flash memory chip FC is about to enter period t2, the number of bad blocks or the number of uses of the reserved blocks rapidly increases. Thus the number of bad blocks may be used as an indication of end-of-life state.

Referring again to FIGS. 1 and 2, in some embodiments the storage system 200 may be configured to monitor (S120) the performance of the first unit storage among the unit storages UST1, UST2, . . . , USTN in operation to determine the number or ratio of bad blocks of the first unit storage, to determine the number of reserved blocks used for remapping the bad blocks. At this time, the number of erasures of bad blocks of the first unit storage may be determined by averaging the number of erasures of all or some of the plurality of memory blocks included in the first unit storage. When the average of the number of erasures of partial memory blocks is used, the partial memory blocks may be densely positioned in an arbitrary region or may be randomly or regularly dispersed.

The storage system 200 may simultaneously or separately perform the above-described monitoring and determining operations on the respective unit storages UST1, UST2, . . . , USTN. In these embodiments as well, when the first type of request is received for the first unit storage when it's been determined to be in the first state, the storage system 200 will process (S160) the first type of request using the second unit storage.

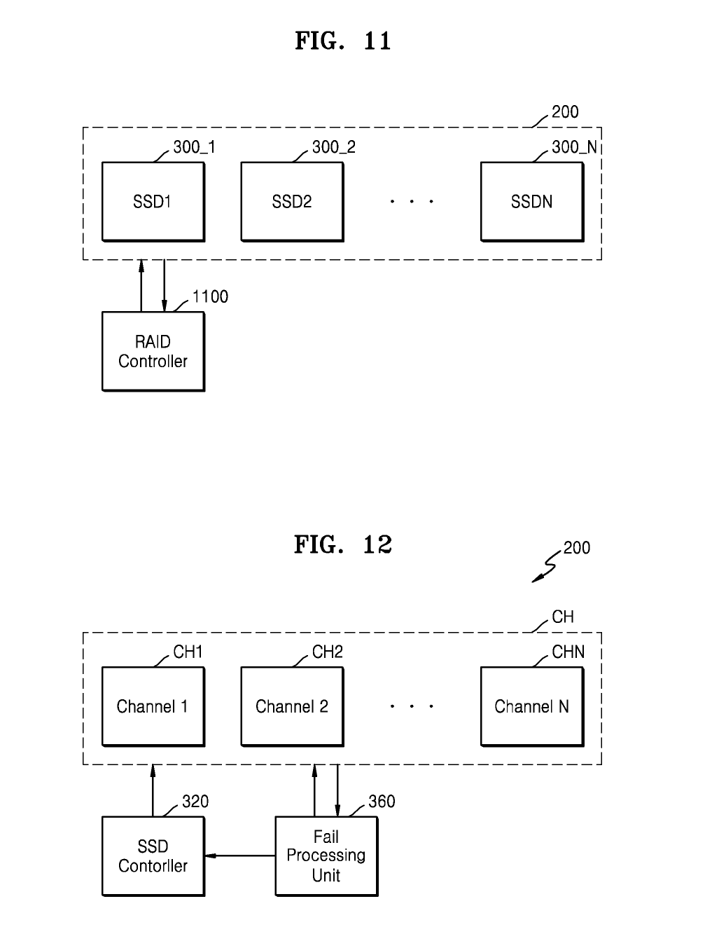

FIGS. 8A and 8B illustrate physically replacing the first unit storage of FIG. 1 with a second unit storage. First, with reference to FIG. 8A, when the first unit storage determined to be in the first state is Unit Storage 2 (UST2), it may be removed from the storage system 200 and a new unit storage, Unit Storage 2′ (UST2′), may be inserted into the storage system 200. The first type of request for Unit Storage 2 (UST2), for example, may then be performed by Unit Storage 2′ (UST2′). At this time, since the same physical address as that of the Unit Storage 2 (UST2) is allotted to the Unit Storage 2′ (UST2′), updating the above-described mapping table 324 may not be necessary.

As illustrated in FIG. 8B, when the first unit storage determined to be in the first state is the Unit Storage 2 (UST2), the first type of request for Unit Storage 2 (UST2) may be processed using spare storage SST. The spare storage SST may be implemented by the same structure as that of each of the unit storages UST1, UST2, . . . , USTN. The number of spare storages SST may vary in accordance with the required performance of the storage system 200. In this case, since a different physical address from that of the Unit Storage 2 (UST2) is allotted to the spare storage SST, the mapping table 324 is updated or remapped. A plurality of spare storages SST may be provided.

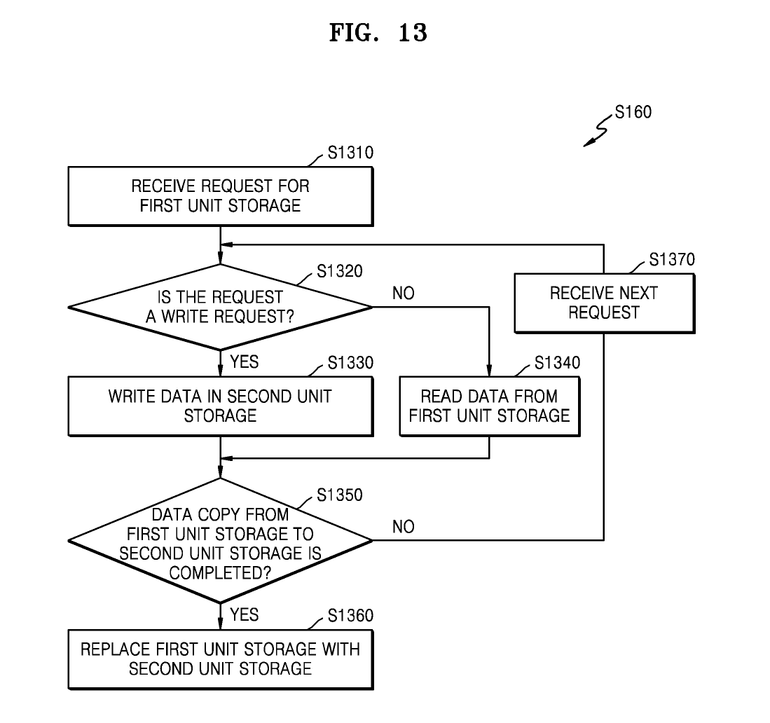

Referring to FIGS. 2 and 9, each of the N unit storages UST1, UST2, . . . , USTN included in the storage system 200 may be implemented by one flash memory chip. Flash memory chips FC1, FC2, . . . , FCN may be connected to channels CH1, CH2, . . . , CHM (shown in FIG. 3), respectively, to be activated in response to corresponding chip enable signals. Each of the flash memory chips FC1, FC2, . . . , FCN may include one flash memory die or two or more flash memory dies. Since failure in units of the unit storages UST1, UST2, . . . , USTN, for example, is controlled when performance of the flash memory chip 1 (FC1) corresponding to the number of uses of the flash memory chip 1 (FC1) is monitored and a monitored performance value is larger than a threshold (reference) value, a first request for the flash memory chip 1 (FC1) may be processed not by the flash memory chip 1 (FC1) but by, for example, the flash memory chip 2 (FC2) that is not in the first state.

When the unit storages UST1, UST2, . . . , USTN are implemented by the flash memory chips FC1, FC2, . . . , FCN, respectively, as illustrated in FIG. 9, performances of the flash memory chips FC1, FC2, . . . , FCN may be monitored (S120) by a failure processing unit 360 that may be positioned in the storage system 200 in operation to determine (S140) which flash memory chip is in the first state.

The performance of the flash memory chips FC1, FC2, . . . , FCN may be monitored as described above with the failure processing unit 360 directly monitoring the number of bad blocks, the number of uses of the reserved blocks, the number of erasures of the bad blocks, or the number of remappings of the bad blocks to the reserved blocks from each of the flash memory chips FC1, FC2, . . . , FCN, or by monitoring the SSD controller 320 controlling the flash memory chips FC1, FC2, . . . , FCN. The failure processing unit 360 may determine which flash memory chip is in the first state by comparing the result of the monitoring with a respective reference value set for the number of bad blocks, the number of uses of reserved blocks, the number of erasures of the bad blocks, or the number of remappings of the bad blocks to the reserved blocks of the corresponding flash memory chip.

When it is determined that a particular flash memory chip is in the first state, in exemplary embodiments the failure processing unit 360 will be able to have a first type of request for that particular flash memory chip processed (S160) by another flash memory chip instead. The inventive concept is not limited to those particular embodiments, however. At least one of the monitoring operation (S120), the determining operation (S140), and/or the processing operation (S160) may be performed by the SSD controller 320. In addition, the failure processing unit 360 may be positioned outside the storage system 200, in which case the failure processing unit 360 may monitor and evaluate the performances of the respective flash memory chips FC1, FC2, . . . , FCN based on degrees of latency in processing requests, or input and output speeds of the requests, for the respective flash memory chips FC1, FC2, . . . , FCN. Furthermore, while in exemplary embodiments the first type of request is a write request, in other possible embodiments it may be a different kind of request necessitating processing by a different or replacement flash memory chip or other type of unit storage.

With reference to FIGS. 2 and 10, in another possible embodiment of the storage system of FIG. 2, the N unit storages UST1, UST2, . . . , USTN included in the storage system 200 may be implemented by SSDs 300_1, 300_2, . . . , 300_N, respectively, which correspond to the SSD 300 described with reference to FIG. 3. In operating the storage system 200, since failure is controlled in units of the unit storages UST1, UST2, . . . , USTN, for example, performance of the SSD1 300_1 may be monitored based on the number of uses of the SSD1 300_1 and, when that number is larger than a threshold value (a reference value), a first type of request for the SSD1 300_1 may be processed not by the SSD1 300_1 but by another SSD that is not in the first state, for example, the SSD2 300_2.

When the unit storages UST1, UST2, . . . , USTN are implemented by the SSDs 300_1, 300_2, . . . , 300_N as illustrated in FIG. 10, performances of the SSDs 300_1, 300_2, . . . , 300_N may be monitored (S120) by the host 400 positioned outside the storage system 200 and it may be determined (S140) which SSD is in the first state based on the monitoring, for example by directly monitoring the number of bad blocks, the number of uses of reserved blocks, the number of erasures of bad blocks, or the number of remappings of bad blocks to reserved blocks of each of the SSDs, as described above, for example by averaging values for all or some of a plurality of flash memory chips, or values of the respective flash memory chips included in the SSDs 300_1, 300_2, . . . , 300_N.

The host 400 may also determine an EOL state by monitoring degrees of latency in processing requests and/or input and output speeds of the requests for the respective SSDs 300_1, 300_2, . . . , 300_N. The input and output speeds may be measured in an arbitrary period, for example whenever IOs for the corresponding SSDs are generated or whenever an arbitrary number of IOs are generated. The input and output speeds of the requests for the respective SSDs 300_1, 300_2, . . . , 300_N may also be measured by the number of IOs generated in a random period. The host 400 may also determine which SSD is in the first state by comparing the result of the monitoring to a reference value set for the number of bad blocks, the number of uses of reserved blocks, the number of erasures of bad blocks, or the number of remappings of bad blocks to reserved blocks of the corresponding SSD, or by comparing a reference value to input and output speed of a request for the corresponding SSD.

When it is determined that an arbitrary SSD is in the first state, the host 400 may control the first request for the corresponding SSD to be performed or processed (S160) by another SSD that is not in the first state by, for example, transmitting a control signal to the corresponding SSD. The inventive concept is not limited thereto, however. At least one of the monitoring operation S120, the determining operation S140, and/or the processing operation S160 may be performed by an arbitrary SSD that is not the host 400. In addition, as illustrated in FIG. 11, monitoring (S120), determining (S140), and processing (S160) of the respective SSDs 300_1, 300_2, . . . , 300_N that are the respective unit storages UST1, UST2, . . . , USTN may be performed by a RAID controller 1100 instead of by the host 400.

The respective unit storages UST1, UST2, . . . , USTN may be set in various units other than the embodiments described with reference to FIGS. 9 to 11. For example, as illustrated in 12, each of the N unit storages UST1, UST2, . . . , USTN included in the storage system 200 may be a plurality of flash memory chips connected to the respective channels CH1, CH2, . . . , CHM illustrated in FIG. 3. For example, the unit storage 1 (UST1) may comprise the plurality of flash memory chips connected to the channel 1 (CH1), and the Unit Storage 2 (UST2) may comprise the plurality of flash memory chips connected to the channel 2 (CH2).

It will thus be understood that failure in the operation of storage system 200 may be controlled in units of the unit storages UST1, UST2, . . . , USTN, for example, by monitoring performance of the flash memory chips connected to the channel 1 (CH1) by monitoring the number of uses of the flash memory chips and, when that number is larger than a threshold value (a reference value), processing requests for the flash memory chips connected to the channel 1 (CH1) by another channel that is not in the first state, for example, channel 2 (CH2). With reference to FIG. 12, the above-described operations may be performed by the failure processing unit 360 or the SSD controller 320 as in FIG. 9, or may be performed by a channel controller (not shown) included in each of the channels CH1, CH2, . . . , CHM.

As described above, in the storage device, storage system, and method of operating a storage system according to one or more possible embodiments of the inventive concept, when it is predicted that performance of the storage device or the storage system will deteriorate, a storage device or the storage system is replaced with another storage device or another storage system before failure occurs, so that performance of the storage device or the storage system may be maintained. In addition, optimized units of the unit storages may be set, respectively, in consideration of required performance of the storage device or the storage system and resources that the storage device or the storage system includes, and performance of the respective unit storages may be monitored by respective unit storages to maintain performance of the respective unit storages and to improve performance of the storage device or the storage system. Furthermore, the number of reserved blocks that must be sufficiently provided against an unexpected failure occurring may be reduced so that production cost and layout area of the storage device or the storage system may be reduced.

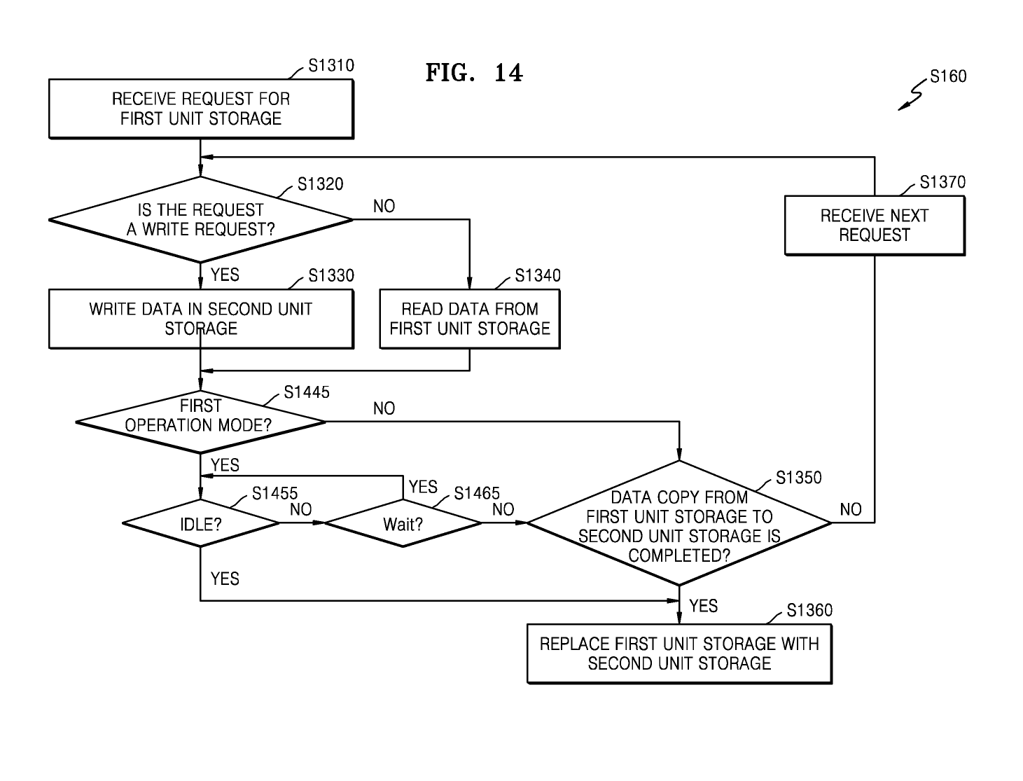

A list of unit storages determined to be in the first state may be stored in an arbitrary storage space (for example, a register or a cache) in the storage system. Referring to FIG. 13, when a request for the first unit storage determined to be in the first state is received (S1310), it is determined whether an address corresponding to that request is for a unit storage included in the corresponding list, so that it may be determined (S1320) whether the request is a read request or a write request.

If the request is a write request it may be processed by writing (S1330) data into the second unit storage, because if data were to be written into the first unit storage, that would increase the P/E cycle of the first unit storage, deteriorating the performance of the first unit storage and bringing the first unit storage in the first state (the EOL state) even closer to failure. Writing the data to the second unit storage instead of the first unit storage is performed to keep this from happening.

Conversely, if the first request is not a write request but a read request, the first request may be performed by reading (S1340) data from the first unit storage. This should not increase the P/E cycle of the first unit storage, so its performance should not deteriorate.

Once data needs to be written to the second unit storage instead of the first storage, copying of all the data from the first unit storage to the second unit storage may commence. This copy may have begun earlier, for example as soon as performance monitoring indicates that the first unit storage is in an end-of-life state. For example, when the first unit storage in the first state is the flash memory chip 1 (FC1) as illustrated in FIG. 9, all data written in the flash memory chip 1 (FC1) may be copied into another flash memory chip, for example, the flash memory chip 2 (FC2) that is not in the first state. If (S1350) a request is processed once the first unit storage is in the first state but copying from the first data storage to the second data storage has not yet been completed, the next request when received (S1370) may be processed as before. But if copying from the first data storage to the second data storage has been completed, then the first unit storage may be replaced (S1360) with the second unit storage, and subsequent requests for the first unit storage may be performed using the second unit storage.

The above-described operations may be performed by the SSD controller 320 or the failure processing unit 360, or may be performed under the control of the external host 400 or the RAID controller 1100. For example, before the copying of data from the first unit storage to the second unit storage is completed, mapping information of the address corresponding to the first request may be set for both the first unit storage and the second unit storage. When it has been determined [S1350] that the copying of data from the first unit storage to the second unit storage has been completed, the mapping information of the address corresponding to the first request may be set only for the second unit storage. The mapping information may be stored in and updated by the mapping table 324 of FIG. 4 for example.

In exemplary embodiments, by processing a new write request for a unit storage in the EOL state using another unit storage while processing a read request using the same unit storage, it may be possible to minimize latency in physically replacing one unit storage with another unit storage. In some embodiments however, the first unit storage may be replaced with the second unit storage before the copying of data from the first unit storage to the second unit storage is completed.

Referring to FIG. 14, in some possible embodiments, once a request for the first unit storage has been received (S1310) and it has been determined (S1320) whether the request is a write request or a read request, and after either a write request for the first unit storage is processed (S1330) using the second unit storage or a read request for the first unit storage is processed (S1340) using the first unit storage, before replacing (S1360) the first unit storage with the second unit storage, a determination (S1445) is made as to whether the storage system is operating in a first mode. If it is, then the storage system may be checked (S1455) to see whether the storage system is in an idle state.

If the storage system is in a first operation mode and is in an idle state, the first unit storage is replaced (S1360) with the second unit storage so that all requests for the first unit storage are performed using the second unit storage. On the other hand, if the storage system is in the first operation mode but is not in an idle state, a determination is made (S1465) as to whether the system should stand by until it is in an idle state. If so then the system waits until it is determined (S1455) whether the storage system is in the idle state. If (S1465) the system should not stand by until it is in idle mode or if (S1445) the system was not in first operation mode, then the process continues with the check (S1350) as explained above as to whether data transfer or copying from the first unit storage to the second storage has been completed, and if it has not then the next request is processed.

Once either the system is in first operation mode and not in an idle state, or the system is not in the first operation mode and the data copy from the first unit storage to the second unit storage is complete, then the first unit storage is replaced (S1360) with the second unit storage so that subsequent requests for the first unit storage are performed using the second unit storage.

Accordingly, in above-described embodiments, when a unit storage is in the EOL state a new write request is performed by another unit storage, while latency in replacing one unit storage with another unit storage is minimized by allowing read requests (which do not deteriorate performance of the corresponding unit storage) to be performed without changing the corresponding unit storage.

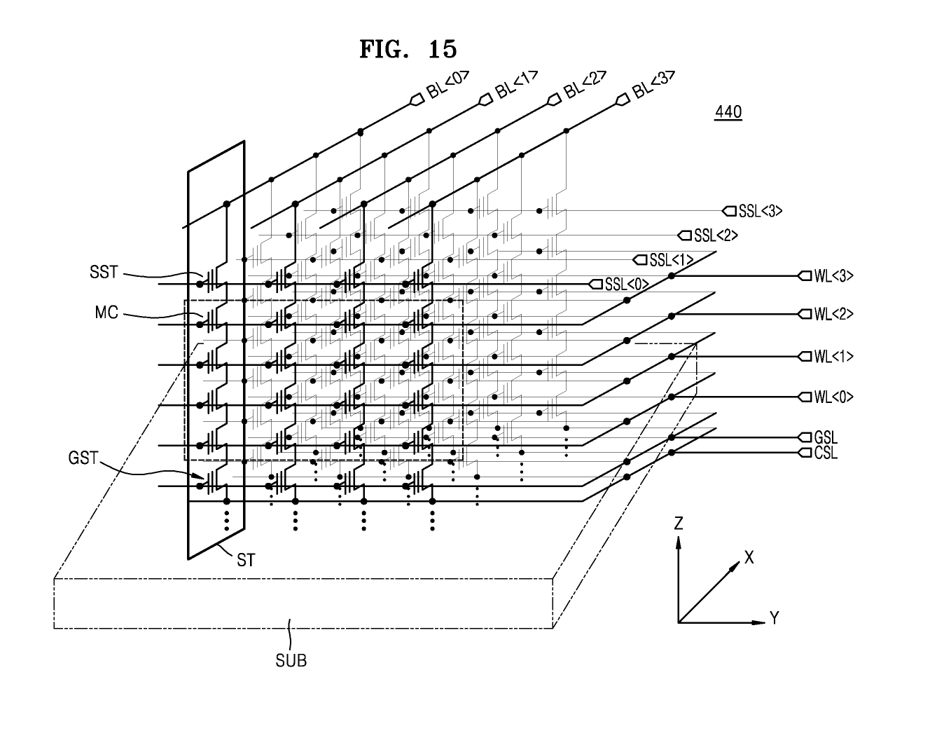

Referring to FIG. 15, a cell array included in the flash memory chip FC of FIG. 3 may be a two-dimensional NAND flash memory or may be implemented by a three-dimensional vertical NAND flash memory cell array 440 including a substrate SUB, a plurality of memory cell strings ST, word lines WL<0> to WL<3>, and bit lines BL<0> to BL<3>. The memory cell strings ST may extend in a direction (for example, a vertical direction Z) that protrudes from the substrate SUB. Each of the memory cell strings ST may include memory cells MC, source selection transistors SST, and a ground selection transistor GST in the Z-axis direction. The source selection transistors SST may be connected to source selection lines SSL<0> to SSL<3> that extend in a column direction Y to be controlled. The ground selection transistor GST may be connected to a ground selection line GSL that extends in a row direction X and the column direction Y to be controlled.

The word lines WL<0> to WL<3> may be arranged in the direction Z vertical to the substrate SUB. Each of the word lines WL<0> to WL<3> may be positioned in a part of a layer where the memory cells MC are provided in the memory cell strings ST. Each of the word lines WL<0> to WL<3> may be combined with the memory cells MC arranged in a matrix in the X-Y plane on the substrate SUB. The bit lines BL<0> to BL<3> may be connected to memory cell strings ST arranged in the row direction X. The memory cells MC, the source selection transistors SST, and the ground selection transistors GST in the memory cell strings ST may share the same channel. The channel may be formed to extend in the direction Z vertical to the substrate SUB.

An appropriate voltage is applied to the word lines WL<0> to WL<3> and the bit lines BL<0> to BL<3> so that a programming operation and/or a verifying operation for the memory cells MC may be performed. For example, a set voltage may be applied to the source selection lines SSL<0> to SSL<3> and the bit lines BL<0> to BL<3> connected to the selection transistors SST so that arbitrary memory cell strings ST may be selected, and a set voltage may be applied to the word lines WL<0> to WL<3> so that arbitrary memory cells MC are selected from the selected memory cell strings ST. Thus a read operation, a programming operation, and/or a verifying operation for the selected memory cells MC may be performed.

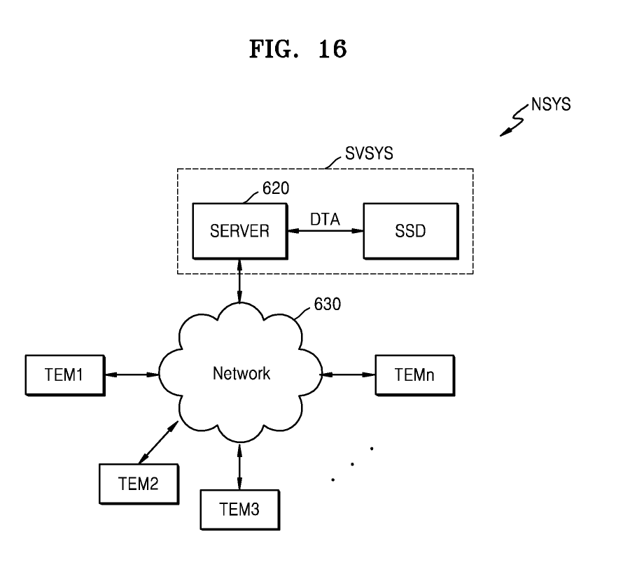

Referring to FIG. 16, a network system NSYS may comprise a server system SVSYS including the SSD of FIG. 3 and a plurality of terminals TEM1 through TEMn connected through a network 630. The server system SVSYS may include a server 620 for processing requests received from the plurality of terminals TEM1 to TEMn connected to the network 630 and the SSD for storing data items corresponding to the requests received from the terminals TEM1 to TEMn. Therefore, the network system NSYS and the server system SVSYS may reliably perform authentication between the SSD controller 320 and a memory so that reliability thereof may be secured.

While the inventive concept has been particularly shown and described with reference to exemplary embodiments thereof, it will be understood that various changes in form and details may be made therein without departing from the spirit and scope of the following claims. For instance, only embodiments in which the storage device is the flash storage device have been illustrated. However, the inventive concept is not limited thereto and various non-volatile storage devices other than the flash storage device may be used as the storage device. As another example, the above-described monitoring operation may be periodically or randomly performed by the storage system or alternatively may be performed when a request for reporting a state of the storage system is received from the external host.

What is claimed is:

1. A method of operating a storage system including a plurality of unit storages each including at least one flash memory chip, the method comprising:
monitoring performance a first unit storage among the plurality of unit storages;
determining that the first unit storage is in a first state when a monitored performance value of the first unit storage exceeds a reference value; and
if a first type of request for the first unit storage is received subsequent to a determination that the first unit storage is in the first state, then using a second unit storage different from the first unit storage to process the first type of request.

2. The method of claim 1, wherein each of the plurality of unit storages includes a respective flash memory chip.

3. The method of claim 1, wherein each of the plurality of unit storages includes a respective solid state drive (SSD).

4. The method of claim 1, wherein monitoring performance of the first unit storage comprises monitoring at least one of:
the number of bad blocks;
the number of remappings of bad blocks to reserved blocks; and
the number of erasures of bad blocks of the first unit storage.

5. The method of claim 4, wherein the number of erasures of bad blocks of the first unit storage is determined by averaging the number of erasures of all or some of the plurality of memory blocks included in the first unit storage.

6. The method of claim 1, wherein monitoring performance of the first unit storage comprises measuring latency in processing a request for the first unit storage and input and output speed of the request for the first unit storage.

7. The method of claim 1, wherein determining that the first unit storage is in the first state comprises determining whether the first unit storage is in an end-of-life state.

8. The method of claim 1, wherein processing the first type of request using the second unit storage includes mapping a logic address included in the first type of request to a physical address of the second unit storage that is spare storage of the storage system.

9. The method of claim 1, wherein the first type of request is a write request.

10. The method of claim 9, wherein:
if a second type of request for the first unit storage is received subsequent to the determination that the first unit storage is in the first state, and the second type of request is a read request, then using the first unit storage to process the read request.

11. The method of claim 9, including:
copying all data stored in the first unit storage to the second unit storage in response to the write request; and
mapping logic addresses included in all requests for the first unit storage to physical addresses of the second unit storage once all the data stored in the first unit storage has been copied to the second unit storage.

12. The method of claim 9, including mapping logic addresses included in all the requests for the first unit storage to the physical addresses of the second unit storage when the storage system is in an idle state.

13. The method of claim 1, including:
if a second type of request for the first unit storage is received subsequent to a determination that the first unit storage is in the first state, the second type of request being different from the first type of request, then using the first unit storage to process the second type of request

14. A method of operating an SSD, the method comprising:
monitoring performance of each of a plurality of flash memory chips of the SSD including at least first and second flash memory chips;
determining, based on the monitoring, that a first flash memory chip among the plurality of flash memory chips is in an end-of-life state;
subsequent to determining that the first flash memory chip is in an end-of-life state, receiving a request for the first flash memory chip;
if the request is a write request, then using the second flash memory chip to process the write request; and
if the request is a read request, then using the first flash memory chip to process the read request.

15. The method of claim 14, including:
copying all data of the first flash memory chip to the second flash memory chip in response to at least one write request for the first flash memory chip occurring after it has been determined that the first flash memory chip is in an end-of-life state; and
replacing the first flash memory chip with the second flash memory chip once it has been determined that all the data of the first flash memory chip has been copied to the second flash memory chip.

16. A storage system comprising:
a plurality of flash memory chips including at least first and second flash memory chips; and
a controller communicatively connected with the plurality of flash memory chips and configured to:
monitor performance of and control the flash memory chips;
determine, based on the monitoring, whether the first flash memory chip is in an end-of-life state;
receive a write request for the first unit storage;
use the first flash memory chip to process the write request if the first flash memory chip has not been determined to be in the end-of-life state; and
use the second flash memory chip to process the write request if the first flash memory chip has been determined to be in the end-of-life state.

17. The storage system of claim 16, including:
a plurality of channels connecting the controller to the plurality of flash memory chips;
a first port able to connect the controller to a host and through which the write request may be received from the host; and
an auxiliary power supply configured to receive external power via a second port from the host or another source.

18. The storage system of claim 16, wherein the controller is configured to:
receive a read request for the first unit storage; and
use the first flash memory chip to process the read request after the first flash memory chip has been determined to be in the end-of-life state.

19. The storage system of claim 16, wherein the first flash memory chip or the second flash memory chip include comprises a three-dimensional memory array.

20. The storage system of claim 16, wherein the controller is configured to:
transfer data from the first flash memory chip to the second flash memory chip in response to the write request received when the first flash memory chip has been determined to be in the end-of-life state; and
replace the first flash memory chip with the second flash memory chip once the data has been transferred from the first flash memory chip to the second flash memory chip.
